(19) United States
(12) Patent Application Publication
(10) Pub. No.: US 2013/0057162 A1
(43) Pub. Date: Mar. 7, 2013

(54) Circuit arrangement for operating at least one discharge lamp and at least one LED

(71) Applicant: Thomas Pollischansky, Muenchen (DE)

(72) Inventor: Thomas Pollischansky, Muenchen (DE)

(73) Assignee: OSRAM AG, Muenchen (DE)

(21) Appl. No.: 13/696,082

(22) PCT Filed: Mar. 21, 2011
(86) PCT No.: PCT/EP2011/054246

§ 371 Date: Nov. 5, 2012

(30) Foreign Application Priority Data
May 19, 2010 (DE) 10 2010 029 100.5

(51) Int. Cl. H05B 35/00

(52) U.S. Cl. 315/182

(57) ABSTRACT

The invention relates to a circuit arrangement for operating at least one discharge lamp (FL1) and at least one LED (D5, D6, Dn), wherein the connection of the LEDs has so-called SELV insulation.

### TECHNICAL FIELD

The invention relates to a circuit arrangement for operating at least one discharge lamp and at least one LED, including: one input with a first and second input connection for connection to an alternating current supply voltage, a first output with a first and a second output connection for connection to the at least one discharge lamp, a second output with a third and fourth output connection for connection to the at least one LED, a first rectifier, with a rectifier input, which includes a first and a second rectifier input connection, wherein the first rectifier input connection is connected to the first input connection and the second rectifier input connection is connected to the second input connection, and a rectifier output with a first and a second rectifier output connection, a storage capacitor which is connected between the first and the second rectifier output connection, an inverter which includes a bridge circuit, wherein the bridge circuit includes at least the series connection of a first and a second electronic switch, wherein between the first and the second electronic switch a first bridge center is formed, and a first inductor, which is connected between the first bridge center and the first output connection.

### PRIOR ART

Such a circuit arrangement is known from WO 2007/066252 A1.

The disadvantage of the circuit arrangement known from this printed publication is that the LED and the fluorescent lamp cannot be switched on separately from each other.

A circuit arrangement of this type is also known from DE 10 2005 030 115 A1, in which the LED and the fluorescent lamp can also only be operated together. With regard to energy-efficient operation, it is however desirable to be able to operate at least one of the two light sources independently of the other. The latter would, for example, make it possible to operate the LED to realize emergency lighting, while the discharge lamp is only activated if a user is present.

In addition, reference is made to DE 10 2007 049 397 A1, in which it is possible to switch between the operation of an LED and the operation of a fluorescent lamp, although the circuit arrangement presented there operates as a buck converter when the LED is operated. Only the upper half-bridge switch is connected. The lower one remains open during LED operation. The control to switch between LED operation and fluorescent lamp operation is expensive, as a raised switch must be connected for this purpose, usually requiring a high-side driver. In addition, there is no electrical insulation between the alternating current supply voltage and the LED, for which reason this circuit arrangement fails to meet the so-called SELV (Safety Extra Low Voltage) requirements customary for LED operating devices.

### DISCLOSURE OF THE INVENTION

The object of the present invention is to develop a generic circuit arrangement such that the operation of at least one of the two light sources is made possible independently of the operation of the other light source. Furthermore, such a circuit arrangement is intended to meet the SELV requirements, in other words, alternating current supply voltage and LED output should be electrically isolated. Finally, the circuit arrangement should be economical to realize.

These objects are achieved by a circuit arrangement with the features of claim 1.

The present invention is based on the knowledge that these objectives can be achieved if for the time being the at least one LED is supplied via a transformer which is connected to the inductor, in other words the lamp choke, wherein measures must be taken to switch this supply on and off. According to the invention a generic circuit arrangement therefore also includes a first transformer with a primary winding and a secondary winding, wherein the primary winding is connected in series to the first inductor. It furthermore includes a second rectifier, which is connected between the secondary winding of the first transformer and the second output. Finally, it includes a switching appliance with a fourth electronic switch, wherein the switching appliance is connected to the primary winding of the first transformer in order to control a current flow through the primary winding of the first transformer.

In such a circuit arrangement the SELV requirements can be met for the operation of the at least one LED. In addition, it is possible to operate the discharge lamp and the at least one LED separately from each other. Thus, for example, the lighting can be realized as emergency lighting by means of the at least one LED, while the at least one discharge lamp is switched on if full lighting is required. A circuit arrangement according to the invention uses the rectifier connected to the input, the storage capacitor and the inverter in both operating modes, in other words both during fluorescent as well as LED operation. The circuit arrangement according to the invention can therefore be realized extremely economically.

A preferred embodiment is characterized by the fact that a voltage transformer, in particular a boost converter, is connected between the storage capacitor and the inverter. The bandwidth of the discharge lamp to be operated with the present circuit arrangement can be expanded by this and its operation made possible largely independently of the alternating current supply voltage.

The first output connection is preferably connected to the terminal of the first inductor facing away from the first bridge center. In a first variant the switching appliance is connected in series to the primary winding of the first transformer, in particular between the primary winding of the first transformer and the second rectifier output connection of the first rectifier. If the switching appliance is switched on, this enables the supply of the at least one LED. If the switching appliance is switched off the at least one LED is not operational. As a result of the switching appliance being connected between the primary winding of the first transformer and the second rectifier output connection of the first rectifier, wherein the second rectifier output connection usually represents the reference potential of the part of the circuit arrangement which is connected electrically conductively to the primary winding of the first transformer, it is possible for the switching appliance to be connected without the need for a high-side driver and therefore extremely economically. For example, emergency lighting can be realized by means of the at least one LED, while the at least one discharge lamp is only switched on if lighting is required.

In this variant the second output connection is preferably connected to the second rectifier output connection of the first rectifier, in particular via a first capacitor.

In a second variant the primary winding of the first transformer is connected in series between the second output connection and the second rectifier output connection. In other words, the supply of the at least one LED is therefore connected in series to the discharge lamp. The switching appliance of the primary winding of the first transformer is preferably connected in parallel. Therefore if the switching appliance is switched on, the primary winding is not supplied with power. As a result the at least one LED remains switched off. Vice versa, if the switching appliance is switched off, the at least one LED is switched on in addition to the discharge lamp and supplied with power via the primary winding.

Preferably the switching appliance also includes a third rectifier with a rectifier input and a rectifier output, wherein the rectifier input is connected to the primary winding of the first transformer, wherein the third electronic switch is connected to the rectifier output in parallel. This variant of the switching appliance takes into account that the voltage at the discharge lamp, in particular when igniting the discharge lamp, can be very high. As a result of this, the potential at the switch can fall below zero at times so that when realizing the fourth electronic switch as a MOSFET, its body diode can begin to conduct. This would lead to an undesirable flashing of the at least one LED, which is effectively prevented by the aforementioned measure. With the use of an IGBT for the fourth electronic switch, the problem described can likewise be prevented, although this incurs higher costs.

In accordance with a preferred development, the circuit arrangement also includes a second transformer, wherein the second transformer includes a primary winding and a secondary winding, wherein the primary winding of the second transformer is connected between the first inductor and the primary winding of the first transformer, wherein the secondary winding of the second transformer is connected between the first inductor and the first output connection of the first output. The second transformer acts as a symmetrical transformer here, by means of which the power for the discharge lamp and the supply of the at least one LED is divided into an envisaged winding ratio. This makes it possible to switch between the operating modes “LED operation only” and “simultaneous LED and discharge lamp operation”. Operation of the discharge lamp alone is likewise possible if when the discharge lamp is ignited the switch Q4 is switched off.

Preferably a second capacitor is connected in parallel to the first output. As a result, together with the inductance, in other words the lamp choke, it is possible to ignite the discharge lamp connected to the first output.

In accordance with a preferred development, the circuit arrangement also includes a third output with a fifth and a sixth output connection as well as a second inductor which is connected between the first bridge center and the fifth output connection. This provides an opportunity to operate an additional discharge lamp—namely, independently of the on/off situation of the discharge lamp connected to the first output and the at least one LED connected to the second output. Preferably a third capacitor is connected in parallel to the third output for this purpose. Together with the second inductor, this enables the realization of a resonance circuit for igniting the discharge lamp connected to the third output. The dimensioning can be the same as for the first inductor and the second capacitor; however, it can also be independent of this.

A fourth capacitor is preferably connected in parallel with the second output, which ensures that the power supplied to the at least one LED is smoothed.

A Zener diode is also preferably connected in parallel with the second output, which limits the output voltage supplied to the second output to a prescribed value.

In accordance with an advantageous embodiment an ohmic resistance is connected in series to the fourth electronic switch. This enables the measurement and regulation of the output current at the second output supplied to the at least one LED.

Finally, it can be provided for that the electronic switch of the inverter is arranged in a raised position and the second electronic switch of the inverter in a lowered position, wherein the coupling of the second electronic switch with the fourth electronic switch is designed with low impedance such that the second electronic switch and the third electronic switch can be switched with the same potential. In other words, the control device which serves to control the switches of the inverter can therefore be used without additional expenditure for the control of the fourth electronic switch.

Additional advantageous embodiments result from the subclaims.

### BRIEF DESCRIPTION OF THE FIGURE(S)

Exemplary embodiments of the present invention are now described in more detail below with reference to the enclosed drawing. These show:

FIG. 1 in a schematic diagram a first exemplary embodiment of a circuit arrangement according to the invention;

FIG. 2 in a schematic diagram a second exemplary embodiment of a circuit arrangement according to the invention;

FIG. 3 in a schematic diagram a third exemplary embodiment of a circuit arrangement according to the invention;

FIG. 4 in a schematic diagram a fourth exemplary embodiment of a circuit arrangement according to the invention; and

FIG. 5 in a schematic diagram a fifth exemplary embodiment of a circuit arrangement according to the invention.

### PREFERRED EMBODIMENT OF THE INVENTION

The same reference characters are used below for identical and identically working components. These are therefore only introduced once.

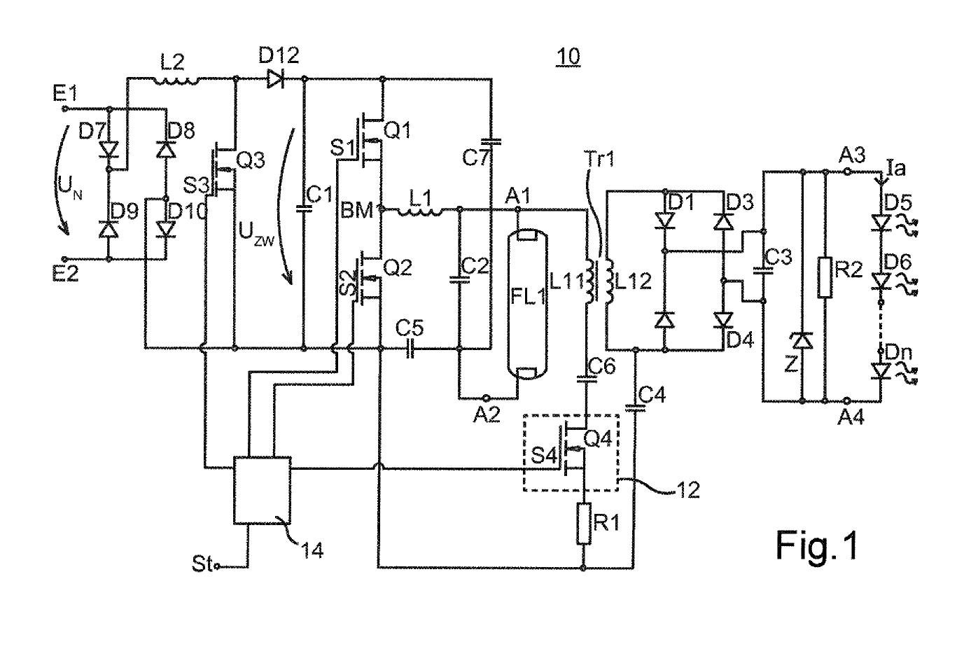

FIG. 1 shows a first exemplary embodiment of a circuit arrangement according to the invention in a schematic diagram. An alternating current supply voltage U_{N}, in particular a mains voltage, can be connected to an input with a first E1 and a second input connection E2. After that there is a first rectifier including the diodes D7, D8, D9 and D10. A line filter can be located upstream of the rectifier D7 to D10. A boost converter is connected to the rectifier, and includes an inductance L2, a diode D12 and an electronic switch Q3 with a control input S3. The control of boost converters is generally known and is therefore not examined in more detail here.

The voltage provided at the output of the boost converter is stored in a capacitor C1. The voltage U_{Zw} dropping across the capacitor C1 is usually described as intermediate circuit voltage. This is supplied to an inverter which includes a half-bridge circuit in this case. It includes a first electronic switch Q1 with a control input S1 and a second electronic switch Q2 with a control input S2. A first bridge center BM1 is defined between these two electronic switches. A lamp choke L1 is connected to the first bridge center BM1, and together with a capacitor C2 forms a resonance circuit, in order to activate a discharge lamp FL1 connected to a first output, which includes the output connectors A1 and A2. Two coupling capacitors C5 and C7 complete the bridge circuit of the inverter.

Also connected to the output A1 is a first transformer Tr1, the primary winding L11 of which is connected in series to the lamp choke L1. A capacitor C6 and a switching appliance 12, which includes a fourth electronic switch Q4 with a control input S4 in this case, are connected in series to the primary winding L11 of the transformer Tr1. A shunt resistance R1 is arranged in series with the switching appliance 12.

The input of a second rectifier, including the diodes D1, D2, D3, D4, is connected to the secondary winding L12 of the first transformer Tr1. A capacitor C3 which serves to smooth the output current of the second rectifier is connected at the output of this second rectifier. A Zener diode Z is connected in parallel with the capacitor C3, and limits the output voltage at a second output including the output connections A3 and A4 to a prescribed value. An ohmic resistance R2 connected in parallel to the capacitor C3 serves to discharge the capacitor C3 so that this is not live when at least one LED D5, D6, Dn is connected to the second output A3, A4. A capacitor C4 connects the primary and the secondary circuit and is typically a Y1 capacitor.

The direct component of the voltage U_{Zw} drops at the coupling capacitors C7 and C5. For operation of the at least one LED D5, D6, Dn, the switch Q4 is closed via the signal S4. As the switch Q4 is connected via a low-impedance resistance R1 to the frame of the circuit arrangement, which represents the potential at the second output connection of the first rectifier, it can be directly controlled by a control device 14. Via the voltage on the ohmic resistance R1 a signal can be measured which is in proportion to the current Iₐ through the at least one LED D5, D6, Dn. This signal can be used as feedback for regulation of the LED current Iₐ.

If the switch Q4 is closed, an alternating current flows through the primary winding L11 of the transformer Tr1 and as a result likewise through the secondary winding L12 of the transformer Tr1. The transformer Tr1 assumes the electrical insulation between the primary and the secondary circuit. The winding ratio determines the amplitude of the output current Iₐ. In order to obtain a constant output current Iₐ regardless of the output load D5, D6, Dn, the inductance of the primary winding of the transformer Tr1 should not be below 5 mH.

When operating the at least one LED D5, D6, Dn, the voltage via the capacitor C2 must be below the maximum permissible voltage before ignition of the discharge lamp FL1. When operating the discharge lamp, the inverter usually starts at a frequency of, for example, 70 to 175 kHz, in order to pre-heat the discharge lamp. After ignition of the discharge lamp FL1, it is then usual to switch to an operating frequency of 40 to 70 kHz. When operating the LED alone, however, an operating frequency of 40 to 70 kHz can be selected from the outset.

The control device 14 can be supplied by a pump circuit from the inverter in both operating modes so that no additional auxiliary supply is required. Switching between LED and fluorescent lamp operation or the operation of both light sources can take place via a control input St at the control device 14.

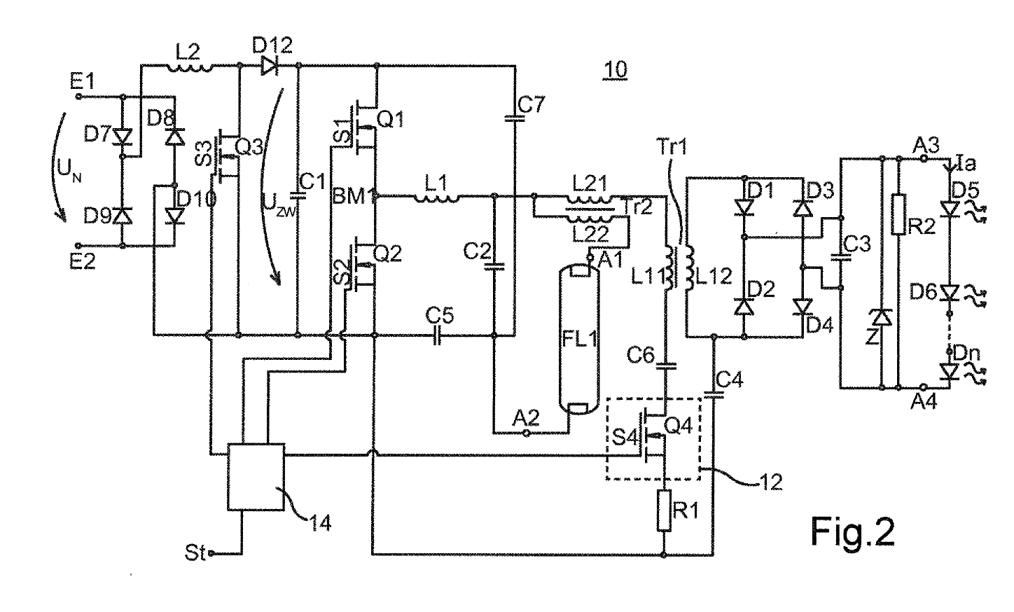

The embodiment shown in a schematic diagram in FIG. 2 of a circuit arrangement 10 according to the invention is characterized in comparison with the embodiment shown in FIG. 1 by the fact that it still includes a symmetrical transformer Tr2. The latter's primary winding L21 is connected between the lamp choke L1 and the primary winding L11 of the transformer Tr1. Its secondary inductance L22 is connected between the lamp choke L1 and the output connection A1. If the switch Q4 is closed, the current for the discharge lamp FL1 and the LED driving circuit, in other words the current which flows through the primary winding L11 of the transformer Tr1, is distributed in a winding ratio of L21 to L22. In this way it is possible to switch between the operating modes “LED operation only” and “simultaneous LED and fluorescent lamp operation”.

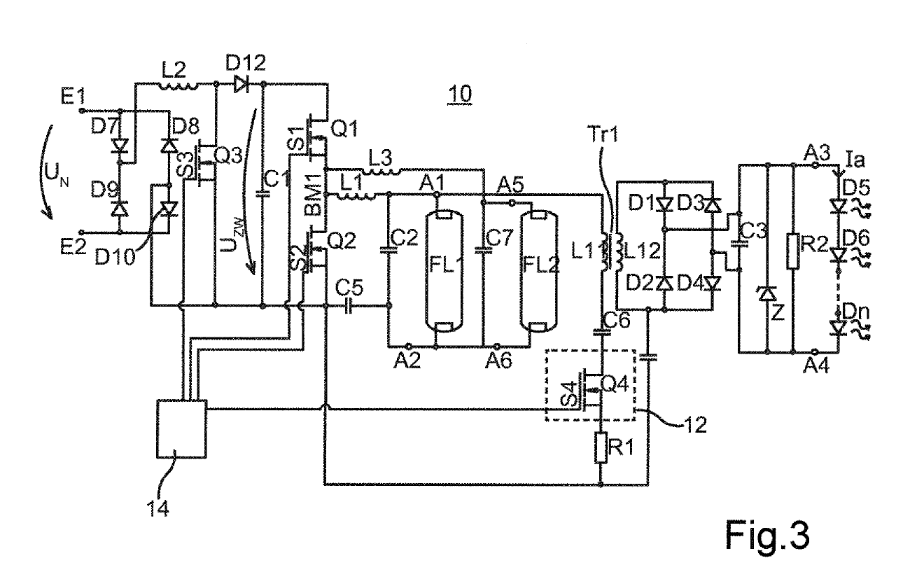

The embodiment shown in a schematic diagram in FIG. 3 of a circuit arrangement 10 according to the invention is distinguished from the embodiment shown in FIG. 1 by the fact that an additional lamp choke L3 is provided, which is connected to the first bridge center BM1. On the one hand, it is connected to an additional output connection A5 and via a capacitor C7 to an additional output connection A6. The output connections A5, A6 form an additional output of the circuit arrangement for connecting an additional discharge lamp FL2. The resonance circuits L1 and C2 on the one hand and L3 and C7 on the other hand are connected in parallel. In the exemplary embodiment of FIG. 3 the discharge lamp FL2 is permanently illuminated while by closing and opening the switch Q4 between the operation of the fluorescent lamp FL1 and the operation of the at least one LED D5, D6, Dn, it is possible to switch back and forth.

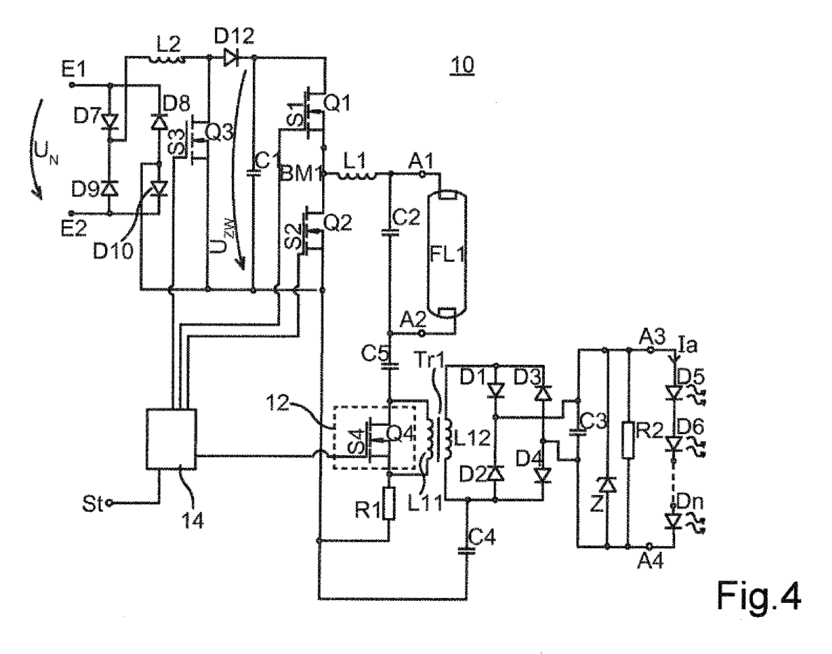

In the embodiment of a circuit arrangement according to the invention shown in FIG. 4 the switching appliance 12 of the primary winding L11 of the transformer Tr1 is connected in parallel. This parallel connection is connected in series to the first output A1, A2. If the switching appliance 12 is switched off, both the discharge lamp FL1 and the at least one LED D5, D6, Dn are illuminated. If the switching appliance 12 is switched on, the primary winding L11 is bridged and only the discharge lamp FL1 is illuminated. Furthermore, the at least one LED D5, D6, Dn can then only be operated if a functional discharge lamp FL1 is used.

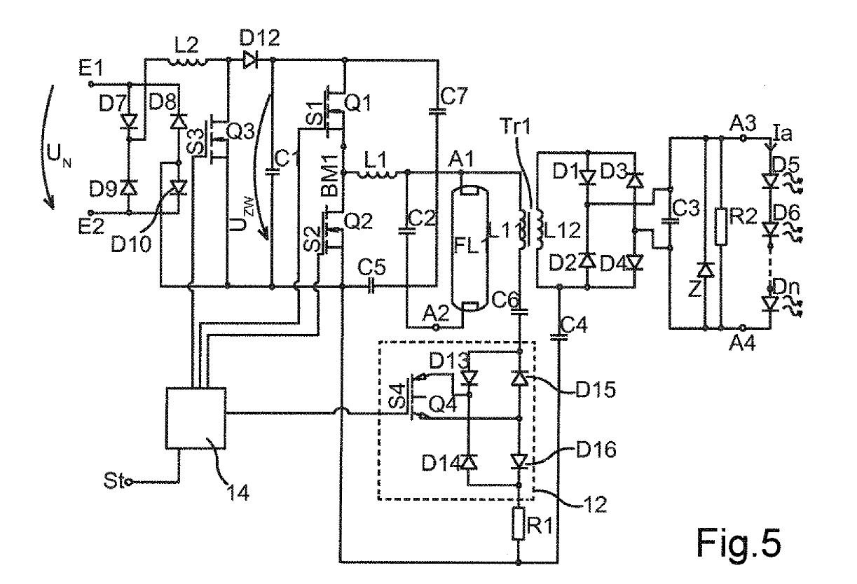

In the embodiment of a circuit arrangement according to the invention shown in FIG. 5 compared with the embodiment shown in FIG. 1 the switching appliance 12 is modified. It also includes a third rectifier including the diodes D13, D14, D15, D16, wherein the rectifier input is connected in series to the primary winding L11 of the transformer Tr1 and wherein the switch Q4 is connected in parallel to the rectifier output. This measure prevents the switching appliance 12 from being switched on unintentionally in an unwelcome manner when forming the switch Q4 as a MOSFET as a result of a high voltage, as may occur, for example, when igniting the discharge lamp FL1, namely as a result of the body diode of the switch Q4. This would result in undesirable flickering of the LEDs D5, D6, Dn.

1. A circuit arrangement for operating at least one discharge lamp and at least one light emitting diode, comprising:
an input with a first and a second input connection for connection to an alternating current supply voltage;
a first output with a first and a second output connection for connection to the at least one discharge lamp;
a second output with a third and a fourth output connection for connection to the at least one light emitting diode;
a first rectifier, with a rectifier input, which comprises a first and a second rectifier input connection, wherein the first rectifier input connection is connected to the first input connection and the second rectifier input connection is connected to the second input connection, and a rectifier output with a first and a second rectifier output connection;
a storage capacitor which is connected between the first and the second rectifier output connection;
an inverter which comprises a bridge circuit, wherein the bridge circuit comprises at least the series connection of a first and a second electronic switch, wherein a first bridge center is formed between the first and the second electronic switch;
a first inductor, which is connected between the first bridge center and the first output connection;
a first transformer with a primary winding and a secondary winding, wherein the primary winding is connected in series to the first inductor;
a second rectifier which is connected between the secondary winding of the first transformer and the second output; and
a switching appliance with a fourth electronic switch, wherein the switching appliance is connected to the primary winding of the first transformer in order to control a current flow through the primary winding of the first transformer.

2. The circuit arrangement as claimed in claim 1, wherein a voltage transformer is connected between the storage capacitor and the inverter.

3. The circuit arrangement as claimed in claim 1, wherein the first output connection is connected to the terminal of the first inductor facing away from the first bridge center.

4. The circuit arrangement as claimed in claim 3, wherein the switching appliance is connected in series to the primary winding of the first transformer.

5. The circuit arrangement as claimed in claim 4, wherein the second output connection is connected to the second rectifier output connection of the first rectifier.

6. The circuit arrangement as claimed in claim 3, wherein the primary winding of the first transformer is connected in series between the second output connection and the second rectifier output connection.

7. The circuit arrangement as claimed in claim 5, wherein the switching appliance of the primary winding of the first transformer is connected in parallel.

8. The circuit arrangement as claimed in claim 1, wherein the switching appliance further also comprises a third rectifier with a rectifier input and a rectifier output, wherein the rectifier input is connected to the primary winding of the first transformer, wherein the third electronic switch is connected in parallel to the rectifier output.

9. The circuit arrangement as claimed in claim 1, wherein the circuit arrangement further comprises a second transformer, wherein the second transformer comprises a primary winding and a secondary winding, wherein the primary winding of the second transformer is connected between the first inductor and the primary winding of the first transformer, wherein the secondary winding of the second transformer is connected between the first inductor and the first output connection of the first output

10. The circuit arrangement as claimed in claim 1, wherein a second capacitor is connected in parallel to the first output.

11. The circuit arrangement as claimed in claim 1, further comprising:
a third output with a fifth and a sixth output connection; and
a second inductor which is connected between the first bridge center and the fifth output connection.

12. The circuit arrangement as claimed in claim 11, wherein a third capacitor is connected in parallel to the third output.

13. The circuit arrangement as claimed in claim 12, wherein a fourth capacitor is connected in parallel to the second output.

14. The circuit arrangement as claimed in claim 1, wherein a Zener diode is connected in parallel to the second output.

15. The circuit arrangement as claimed in claim 1, wherein an ohmic resistance is connected in series to the fourth electronic switch.

16. The circuit arrangement as claimed in claim 1, wherein the first electronic switch of the inverter is arranged in a raised position and the second electronic switch of the inverter in a lowered position, wherein the coupling of the second electronic switch to the fourth electronic switch is designed with such low impedance that the second electronic switch and the third electronic switch can be switched with the same potential.

17. The circuit arrangement as claimed in claim 2, wherein the voltage transformer is a boost converter.

18. The circuit arrangement as claimed in claim 4, wherein the switching appliance is connected in series to the primary winding of the first transformer between the primary winding of the first transformer and the second rectifier output connection of the first rectifier.

19. The circuit arrangement as claimed in claim 5, wherein the second output connection is connected to the second rectifier output connection of the first rectifier via a first capacitor.
